(19) United States
(12) Patent Application Publication
(10) Pub. No.: US 2010/0162711 A1
(43) Pub. Date: Jul. 1, 2010

(54) DLN DUAL FUEL PRIMARY NOZZLE

(75) Inventors: Baifang Zuo, Simpsonville, SC (US); Willy S. Ziminsky, Simpsonville, SC (US); Gilbert Otto Kraemer, Greer, SC (US); Abdul Rafey Khan, Greenville, SC (US); Christian X. Stevenson, Inman, SC (US); Chunyang Wu, Greer, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Compnay

(21) Appl. No.: 12/345,802

(22) Filed: Dec. 30, 2008

(51) Int. Cl. F02C 1/00

(52) U.S. Cl. 60/742

(57) ABSTRACT

The primary nozzles of a Dry Low NOx (DLN) combustor are configured to alternatively burn a first gas fuel or a second gas fuel, where the two gas fuels may have widely disparate energy content. Natural gas may be the first gas fuel and syngas may be the second gas fuel. An inner fuel circuit and an outer fuel circuit are provided to allow effective control of fuel/air mixing profiles, dynamics, primary pre-ignition and emission control by changing the fuel split between the two fuel circuits. The inner fuel circuit may be run in a diffusion combustion mode on many gas fuels.

### BACKGROUND OF THE INVENTION

The invention relates generally to a primary nozzle of a combustor for a DLN gas turbine and more specifically to a dual gas fuel capability for the primary nozzle to operate with natural gas and with syngas.

The regulatory requirements for low emissions from gas turbine power plants have continually grown more stringent over the years. Environmental agencies throughout the world are now requiring even lower rates of emissions of NOx and other pollutants from both new and existing gas turbines. Traditional methods of reducing NOx emissions from combustion turbines (water and steam injection) are limited in their ability to reach the extremely low levels required in many localities.

Dry Low NOx (DLN) systems, by General Electric Co. integrate a staged premixed combustion process, and the gas turbine's SPEEDTRONIC™ controls the fuel and associated systems. Such systems may include two principal measures of performance. One measure is meeting the emission levels required at baseload on both gas and oil fuel while controlling the variation of those levels across the load range of the gas turbine. The second measure is system operability. Design of a DLN combustion system also requires hardware features and operational methods that simultaneously allow an equivalence ratio and a residence time in the flame zone (combustion parameters critical to emission control) to be low enough to achieve low NOx, but with acceptable levels of combustion noise (dynamics), stability at part load operation, and sufficient time for CO burnout.

The DLN-1 combustor by General Electric Co. is a two-stage pre-mixed combustor designed for use with natural gas fuel and capable of operation on liquid fuel. The combustor provides a fuel injection system including a secondary fuel nozzle positioned on the center axis of the combustor surrounded by a plurality of primary fuel nozzles symmetrically arranged around the secondary fuel nozzle. The DLN-1 combustor maintains very low exhaust emission levels while maintaining high levels of efficiency using lean premixed concepts. In a lean premixed combustion process, the fuel and air are delivered separately from supply sources with different dynamic characteristics relative to the premixing zone. Such lean premixed combustion processes are subject to weak limit oscillation cycles that may amplify, leading to large fluctuations in gas pressure and temperature, known as combustion dynamics. Excessive combustion dynamic pressure can lead to damage of the combustor. Combustion dynamic pressure levels for lean premixed combustion systems are reduced by matching the dynamic response of the fuel and air supply systems to the premixer. The DLN-1 combustor primary nozzle reduces dynamic pressure fluctuations in the combustor premixer zone by substantially equalizing the pressure drop across the air and fuel inlets to the premixer zone. The equalization is carried out, in part, by including an orifice in the fuel chamber of the primary nozzle upstream of the discharge orifice from the fuel chamber to the premixer. The upstream orifice provides a fuel pressure in the fuel chamber comparable to the pressure of the air inlet and the discharge orifice provides a fuel pressure drop equivalent to the air supply pressure drop. The resulting pressure fluctuations in the premixer zone resulting from fuel/air concentration oscillations are substantially minimized or eliminated, as described by Black (U.S. Pat. No. 5,211,004).

The DLN-1 combustors are widely used. However, these combustors were designed mainly for natural gas combustion. New customer demands want the combustors to have wider fuel flexibility in view of availability of alternative gas fuels and increased cost for natural gas fuel. More specifically, customers would like a combustor capable of running with a blended syngas and also capable of running with natural gas alone (dual fuel flexible). Syngas (for synthesis gas) is the name given to a mixture of hydrogen and carbon monoxide and sometimes carbon dioxide. Blended syngas may be a mixture of natural gas/hydrogen/carbon monoxide. Syngas is combustible and is often used as a fuel source, but has less than half the volumetric energy density of natural gas. As a volumetric flow rate for syngas must be more than double the volumetric flow rate of natural gas value for the same combustion flame temperature, syngas fuel pressure ratio will be extremely high (over 1.7) if the same primary nozzle presently used for natural gas fuel is also used for operation with syngas. Such a high fuel pressure ratio may demand additional compressors for the fuel supply.

Prior dual fuel nozzle designs were focused on gaseous and liquid dual fuel application, rather than dual gaseous fuels with widely varying Wobbe numbers. Here, the Wobbe number of a fuel is defined by dividing the high heating value of the gas in Btu per standard cubic foot by the square root of its specific gravity with respect to air. The higher a gases' Wobbe number, the greater the heating value of the quantity of gas. Other dual fuel patents, including U.S. Pat. No. 6,837,052 by Martling, adopt adding additional nozzles, which require restructuring of the combustor geometry.

Accordingly, there is a need to provide a DLN-1 combustor with a capability for operation with dual fuels where the dual fuels include dual gaseous fuels with widely disparate Wobbe numbers. Also, the need exists to provide such a dual fuel capability without major modification to the overall combustor structure. Further, the nozzle design should not adversely affect natural gas operability and should ensure syngas combustion provides comparable performance to natural gas combustion in terms of flow, mixing, dynamics, and emission patterns.

### BRIEF DESCRIPTION OF THE INVENTION

Briefly in accordance with one aspect, a dual fuel primary nozzle for a combustor of a gas turbine operating with a secondary nozzle and a plurality of the primary nozzles is provided. The primary nozzles are organized concentrically around the secondary nozzle wherein a gas fuel including a first gas fuel or a second gas fuel, compressed air from the gas turbine compressor, and a purge air are supplied to the duel fuel primary nozzle. The dual fuel primary nozzle includes a mixing chamber. An outer fuel circuit is provided in fluid communication with the mixing chamber and adapted for delivering a swirled mixture of air and either the first gas fuel or the second gas fuel. An inner fuel circuit is provided in fluid communication with the mixing chamber and is adapted for delivering purge air if the outer fuel circuit delivers the first gas fuel and for delivering the second gas fuel if the outer fuel circuit delivers the second gas fuel.

In accordance with a second aspect of the present invention, a method is provided for fabricating a dual fuel primary nozzle for a combustor of a DLN1 gas turbine operating with a secondary nozzle positioned on a center axis of the combustor with a plurality of the primary nozzles organized concentrically around the secondary nozzle. In this arrangement, a first gas fuel, a second gas fuel, a compressed air from the gas turbine compressor, and a purge air may be supplied to the dual fuel primary nozzle.

The method includes fabricating a main body; a mixing chamber downstream from the main body; and a swirler positioned at a forward end of the main body and upstream from the mixing chamber. The swirler includes multiple swirl vanes extending radially from the main body. The swirler also includes means for fluid communication with an outer chamber of the main body for allowing either the first gas fuel or the second gas fuel to enter and with the mixing chamber for discharging a swirled mixture of compressed air and either the first gas fuel or the second gas fuel injected from the outer chamber into the mixing chamber. The method also includes forming a center chamber in the main body, where the center chamber is adapted to receive either a second gas fuel or purge air from an inner fuel circuit and includes means of fluid communication for discharging to the mixing chamber. The method further includes forming an outer chamber in the main body, where the outer chamber is adapted to receive from an outer fuel circuit either the first gas fuel or the second gas fuel and includes means of fluid communication for discharging the first gas fuel or the second gas fuel into the multiple swirl vanes of the swirler.

Further, the method receives compressed air from an external volume (the headend chamber) bounded inward radially by an outer wall of the outer chamber of the main body and bounded on a downstream side by the swirl vanes of the swirler, where the external volume is adapted to receive compressed air from the gas turbine compressor for mixing by the swirl vanes with either the first gas fuel or the second gas fuel from the outer chamber.

Either a first gas fuel or a second gas fuel is received in the outer chamber from the outer fuel circuit. An air purge is received by the inner fuel circuit in the center chamber when the first gas fuel is supplied to the outer chamber. The method also receives the second gas fuel from the inner fuel circuit to the center chamber when second gas fuel is supplied to the outer chamber and once a pressure ratio for the outer fuel circuit reaches a predetermined value.

The fuel pressure ratio for the inner fuel circuit and the outer fuel circuit is maintained below the predetermined value when operating with the second gas fuel in both the inner fuel circuit and the outer fuel circuit.

In accordance with a further aspect of the present invention, a method is provided for operation with a dual fuel primary nozzle for a combustor of a DLN1 gas turbine operating with a secondary nozzle positioned on a center axis of the combustor with multiple primary nozzles organized concentrically around the center nozzle for which a first gas fuel, a second gas fuel, compressed air from the gas turbine compressor, and purge air are supplied to the dual fuel primary nozzle. The method includes forming an outer fuel circuit, forming an inner fuel circuit, and receiving compressed air from an external volume bounded inward radially by an outer wall of the outer chamber of the main body and bounded on a downstream side by the swirl vanes of the swirler, the external volume being adapted to receiving compressed air from the gas turbine compressor for mixing by the swirl vanes with either the first gas fuel or the second gas fuel from the outer chamber;

### BRIEF DESCRIPTION OF THE DRAWING

These and other features, aspects, and advantages of the present invention will become better understood when the following detailed description is read with reference to the accompanying drawings in which like characters represent like parts throughout the drawings, wherein:

FIG. 1 is a schematic illustration of an exemplary gas turbine engine;

FIG. 2 is a simplified view of a DLN combustor;

FIG. 3A illustrates an axial cross section of an embodiment of the dual fuel primary nozzle;

FIG. 3B illustrates the flow of fuel and air through the primary nozzle;

FIG. 4 illustrates an embodiment of a dual fuel primary nozzle viewed from the downstream mixing chamber;

FIGS. 5A and 5B illustrate a comparison for an embodiment of the dual fuel primary nozzle of flow and mixing in the mixing chamber between natural gas operation with and without an air purge; and

FIGS. 6A and 6B illustrate a comparison for an embodiment of the dual fuel primary nozzle of flow and mixing in the mixing chamber between natural gas and syngas operations.

### DETAILED DESCRIPTION OF THE INVENTION

The following embodiments of the present invention have many advantages, including allowing the primary nozzles of a DLN-1 combustor to alternatively burn a first gas fuel or a second gas fuel, where the two gas fuels may have widely disparate energy content. In a preferred embodiment of the present invention, a natural gas may be the first gas fuel and syngas may be the second gas fuel. Further the syngas fuel may be a 20%/36%/44% combination of natural gas/hydrogen/carbon monoxide (NG/H2/CO). This invention guides the design of the DLN combustor's primary nozzle for dual fuel operation (natural gas and H2/CO blended syngas) while maintaining overall performance.

The overall design approach for the combustor is to burn natural gas in the secondary nozzle, with dual fuel capability for the primary nozzles. Thus the combustor may newly operate with 100% natural gas fueling the secondary nozzle and with syngas fueling the primary nozzles or may continue, as before, to operate with 100% natural gas for the secondary nozzle and 100% natural gas for the primary nozzles.

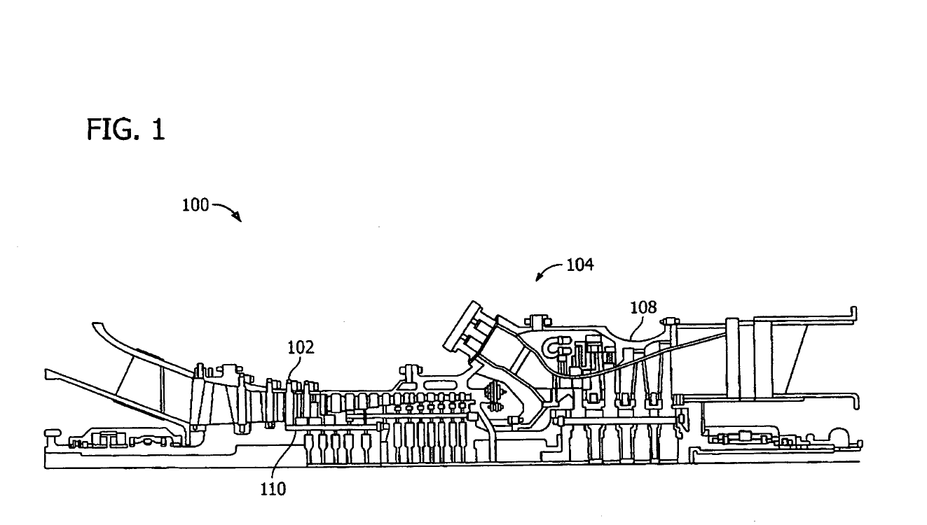

FIG. 1 is a schematic illustration of an exemplary gas turbine engine 100. Engine 100 includes a compressor 102 and a plurality of circumferentially spaced combustors 104. Engine 100 also includes a turbine 108 and a common compressor/turbine shaft 110 (sometimes referred to as a rotor 110).

In operation, air flows through compressor 102 such that compressed air is supplied to combustors 104. Fuel is channeled to a combustor region, within combustors 104 wherein the fuel is mixed with air and ignited. Combustion gases are generated and channeled to turbine 108 wherein gas stream thermal energy is converted to mechanical rotational energy. Turbine 108 is rotatably coupled to, and drives, shaft 110. It should be appreciated that the term “fluid” as used herein includes any medium or material that flows, but not limited to, gas and air.

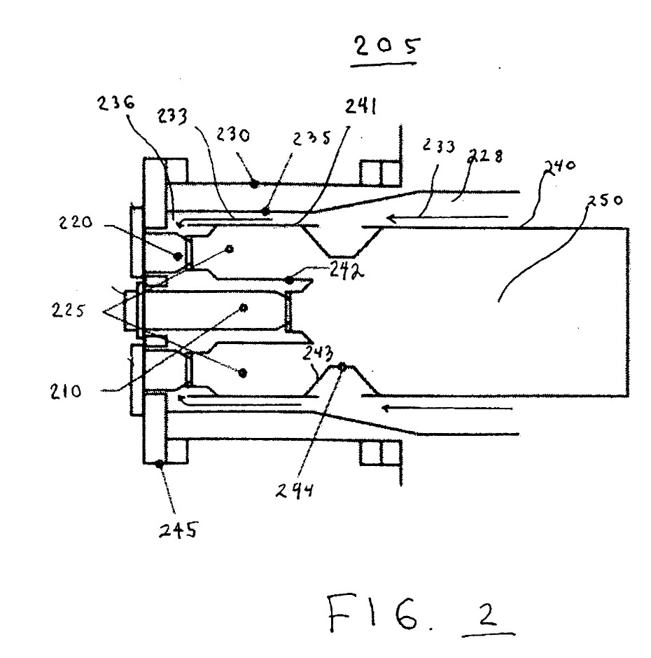

FIG. 2 is a simplified view of a DLN combustor 205. A fuel injection system for the combustor includes a secondary nozzle 210 and multiple primary nozzles 220 organized radially around the secondary nozzle. Pressurized air 233 from the compressor (not shown) is channeled though a flow channel in transition piece between the combustor (not shown) and then through combustion chamber cooling passage 228 between flow sleeve 235 and combustion liner 240. The pressurized air 233 continues into cavity 236 surrounding primary nozzles 220 and secondary nozzle 210. Primary and secondary nozzles are supported by the endcover 245.

In the premix mode, fuel is provided to both primary and secondary nozzles. With the primary nozzles, fuel and air is mixed in mixing chambers 225. The mixing chamber may be formed by the combustor primary wall 241, the cap/centerbody 242, and forward wall 243 of venturi 244. The fuel and air are ignited in the combustion chamber 250. Casing 230 isolates combustion chamber 250 from the outside environment, such as surrounding turbine components. Combustion gases generated are channeled from combustion chamber 250 through transition piece (not shown) towards turbine nozzle (not shown).

Natural gas and syngas have some notably different characteristics that impact operation in a common fuel nozzle. As the volumetric flow rate for syngas is more than double the NG value required for providing the same combustion flame temperature, the syngas fuel pressure ratio would be extremely high (over 1.7) if the same primary nozzle for NG fuel were to be used. The extremely high pressure ratio necessary to drive the greater required volumetric flow of syngas is unacceptable because additional compressors would be needed to compress the gas fuel to such a high pressure. Therefore, to maintain operability of the primary nozzles with natural gas and, at the same time, to reduce its syngas operation pressure ratio, the primary nozzle includes an outer fuel circuit and an inner fuel circuit. With natural gas (NG) operation, the natural gas fuel passes only through the outer fuel circuit and the inner fuel circuit is air purged. With syngas operation, the syngas fuel initially goes through the outer fuel circuit. Once the outer fuel circuit fuel injection pressure ratio reaches a predetermined value (about 1.4, which is considered acceptable for nozzle operation), the inner fuel circuit is opened to maintain the fuel pressure ratio for each nozzle below the predetermined value on both the inner and outer fuel circuits. At the same time, the dual fuel primary nozzle maintains the desirable characteristics of the original DLN-1 primary nozzle with respect to lean mixing and emission control. Further, the dual fuel primary nozzle promotes reduction of dynamic pressure fluctuations in the combustor premixer zone by substantially equalizing the pressure drop across the air and fuel inlets to a premixer zone.

Thus dual fuel capability is achieved by adding a second fuel circuit but without the need for changing the number of nozzles or making major modifications to the structure of the combustor. Dual fuel circuits have many advantages and permit many combinations of fuel types, air and diluents to be injected into the combustion chamber. Two fuel circuits also allow co-firing two different types of fuel with separate controls. Two fuel circuits allow effective control of fuel/air mixing profiles, dynamics, primary pre-ignition and emissions by changing the fuel split between the inner and outer fuel circuits. Two fuel circuits also permit the diluent injection through one of the circuits into the primary chamber. Either of the fuel circuits may be air or diluent purged.

In particular, the inner fuel circuit may be run in a durable diffusion combustion mode on all gaseous fuels. The inner fuel circuit provides a fast fuel/air mixing downstream of the nozzle. An air purge or diluent purge through the inner fuel circuit also results in a negligible impact to natural gas operation provided through the outer fuel circuit.

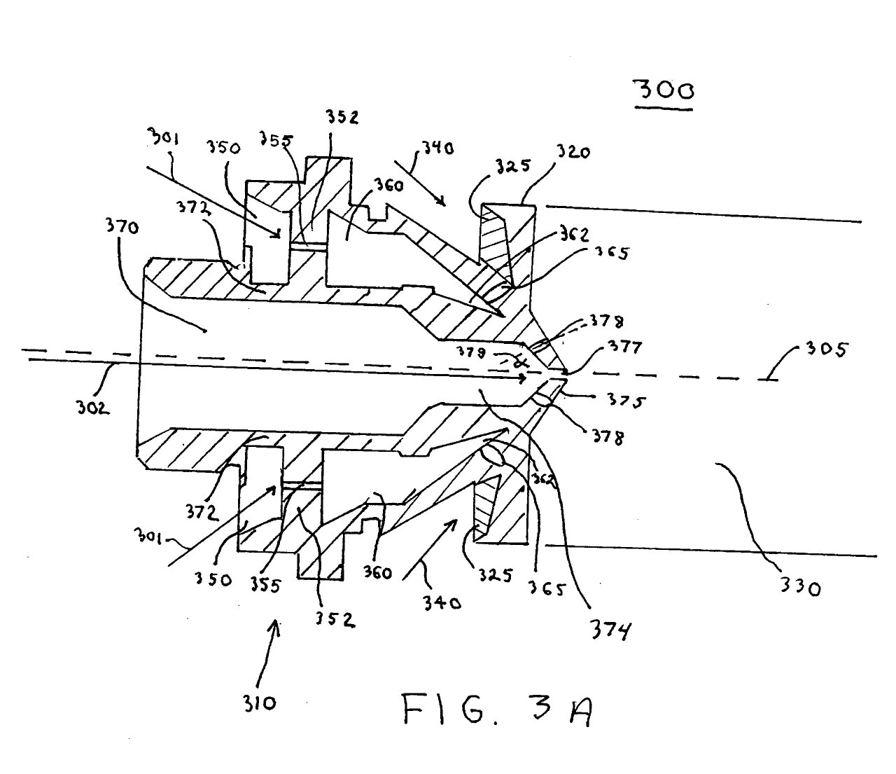

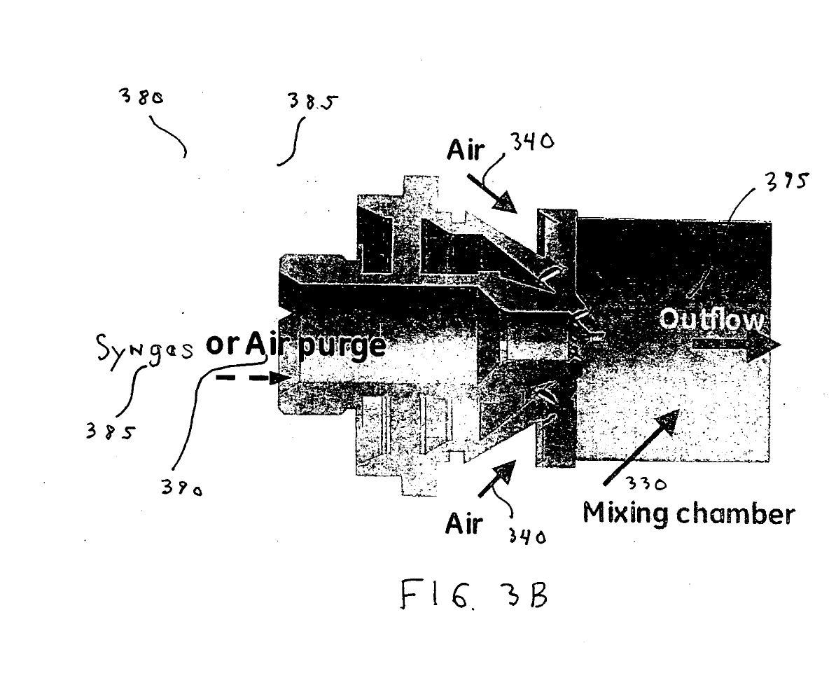

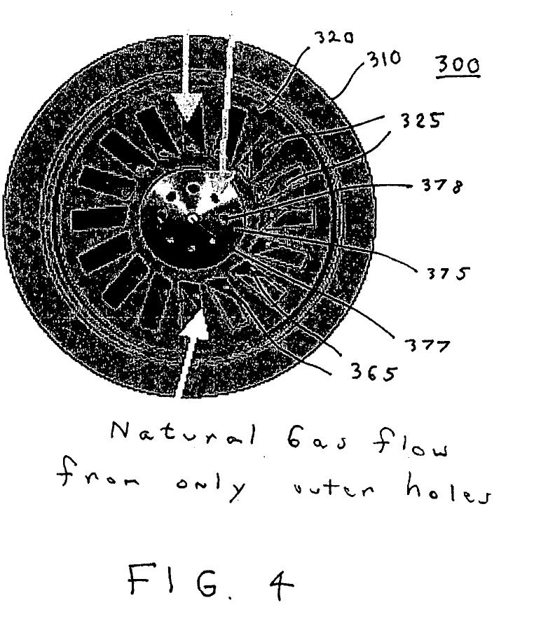

To maintain the primary nozzle's NG operability and, at the same time, to reduce its syngas operation pressure ratio, dual fuel primary nozzle has been provided, as represented in FIG. 3A, FIG. 3B and FIG. 4. FIG. 3A illustrates an axial cross section of an embodiment of the dual fuel primary nozzle. FIG. 3B illustrates the flow of fuel and air through the primary nozzle. FIG. 4 illustrates a view of the dual fuel primary nozzle from the downstream mixing chamber. The dual fuel primary nozzle 300 includes a main body 310, a swirler 320 at a forward end of the main body and a mixing chamber 330 downstream from the main body and the swirler. The main body provides an outer fuel circuit 301 and an inner fuel circuit 302. A compressed air entry 340 is provided external to the nozzle 300 for compressed air from the compressor for the gas turbine to enter swirl vanes 325 of the swirler 320.

The outer fuel circuit 301 includes a primary chamber 350, which receives a gas fuel from an external gas supply through a backplate of the combustor (not shown) and a secondary chamber 360, which receives the gas fuel from the primary chamber 350. The primary chamber 350 and the secondary chamber 360 may be annularly concentric around the central axis 305 of the nozzle 300. The primary chamber 350 and the secondary chamber 360 may be separated by a chamber separator wall 352 that may include a plurality of pre-orifices 355 controlling the flow of the gas fuel between the chambers. A forward end 362 of the secondary chamber 360 may include a plurality of injection holes 365 for discharging the gas fuel into the swirler 320 for mixing with the compressed air 340 from a compressor of the gas turbine (FIG. 1).

The inner fuel circuit 302 includes a central chamber 370, concentric around the central axis 305 of the nozzle 300, which accepts a gas fuel from an external gas supply through the backplate of the combustor (not shown). The central chamber 370 may be separated radially from the primary chamber 350 and the secondary chamber 360 of the first fuel circuit 301 by an annular wall 372 and may taper at a forward end 374. A conical nose 375 of the forward end 374 of the central chamber 370 may extend through the center of the swirler 320 into the mixing chamber 330, thereby allowing discharge from the inner fuel circuit 302 directly into the mixing chamber 330. The conical nose 375 may include a plurality of injection holes. In a preferred embodiment, a central injection hole 377 may be provided along the central axis 305 of the nozzle 300 and eight peripheral injection holes 378 may be symmetrically arranged radially and circumferentially around the central injection hole 377, including an injection angle 379 with respect to the central axis. The injection hole size, injection angle and locations may be arranged to optimize impact on performance of the dual fuel primary nozzle relative to the original DLN primary nozzle and limit differences only locally with respect to nozzle discharge.

In a preferred embodiment of the dual fuel primary nozzle, the plurality of pre-orifices 355 may include 8 axial-directed orifices, symmetrically organized radially and circumferentially about a central axis 305 of the nozzle 300. The preferred embodiment may include 16 injection holes 365 through the forward end 362 of the secondary chamber 360 communicating with the inlet to the swirler 320 wherein the discharge from the outer fuel circuit 301 is swirled with a cross-flow of compressed air 340 from air entry path into the swirler vanes 325. The injection hole size, injection angle 329 and location are optimized to maintain comparable performance to the original fuel primary nozzle and limit differences only locally. The pre-orifices 355 may extend through the chamber separator wall 352 reducing the fuel pressure in the secondary chamber 360 for the plurality of injection holes 365 to approximately a predetermined pressure whereby the air supply entry opening and the injection holes have substantially the same pressure drop, thereby substantially minimizing or reducing fuel-air concentration oscillations in the mixing chamber 330. In this way, the outer fuel circuit 302 replicates the function of the DLN-1 primary nozzle in mitigating fuel-air concentration oscillations in the premixer, thereby facilitating maintenance of combustion dynamic performance.

FIG. 3B provides a representation of the fuel and air paths through the primary nozzle. For operation with natural gas (NG), NG 380 is supplied to the outer fuel circuit and purge air 390 is supplied to the inner fuel circuit. For operation with syngas, syngas 385 is supplied to both the outer fuel circuit and the inner fuel circuit. The mixed fuel and gas (outflow) 395 flows and mixes downstream in mixing chamber 330.

FIG. 4 provides a view of the downstream face of an embodiment of the primary nozzle 300. Within the main body 310, the conical nose 375 of the inner fuel circuit includes central injection hole 377 and peripheral injection holes 378. The swirler 320 includes a plurality of swirl vanes 325 wherein injection holes 365 from the outer fuel circuit inject the gas fuel of the outer fuel circuit into the air flow between the swirl vanes 325. For natural gas operation, the NG is provided only through the injection holes 365 while an air purge is provided through the central injection hole 377 and the peripheral injection holes 378. For syngas operation, the syngas is provided through both injection holes 365 of the outer fuel circuit and the central injection hole 377 and peripheral injection holes 378 of the inner fuel circuit.

Computational fluid dynamics (CFD) simulation tool has been used for design optimization in order to limit the impact locally and to maintain overall performances unchanged. The new design has an outer fuel circuit including a primary fuel chamber, 8 pre-orifices, a secondary fuel chamber, and 16 fuel injection holes. The outer fuel injects toward the swirler air passage, and mixes with the cross flow air. The inner fuel circuit includes a primary chamber and 9 injection holes. The fuel hole size, injection angles, and hole location are optimized using CFD to minimize the impact on overall performances.

A combination of the design parameters, including the fuel pressure ratio, fuel hole size, injector's swirl angle, injector's radial angle, and injector's location, has been chosen for design optimization relative to syngas operation. Results demonstrate that by proper selection of parametric combination, it is possible to limit the impact of fuel effects within the first half of the nozzle. Downstream and near the nozzle exit the flow and mixing patterns with syngas fuel gradually converge to the NG ones.

CFD has been used to optimize the inner fuel circuit fuel hole size, injection angles, and hole location to keep the overall combustor performances high. The newly designed nozzle has been tested for both natural gas and H2/CO blended syngas. Test results demonstrate that the new nozzle performs for both natural gas and H2/CO blended syngas equally well as the single fuel primary nozzle operating with natural gas.

During natural gas operation, the inner fuel circuit must be air purged to keep the downstream combustor flame from backing up into the inner fuel circuit and doing damage. So with NG operation, a significant performance concern is whether the inner fuel circuit purged airflow will affect the nozzle operability. To evaluate NG operability, two nozzle performance cases were simulated. Both performance cases have NG run through the outer fuel circuit, but only one has the inner circuit air purged. These simulation results clearly demonstrate that the air purge through the inner fuel circuit only alters the flow and mixing close to the nozzle injection location. Downstream of the nozzle, flow and mixing patterns completely resemble each other.

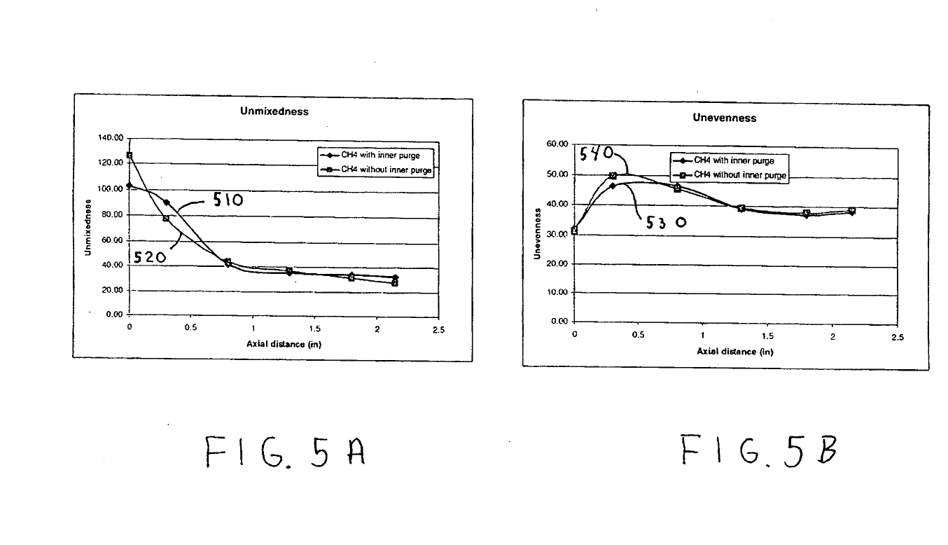

FIG. 5A and FIG. 5B illustrate a comparison for an embodiment of the dual fuel primary nozzle of flow and mixing in the mixing chamber between natural gas operation with and without an air purge. FIG. 5A illustrates cross-section-averaged fuel/air unmixedness along the nozzle axis for natural gas operation with an air purge on the inner fuel circuit 510 and cross-section-averaged fuel/air unmixedness along the nozzle axis for natural gas operation without an air purge on the inner fuel circuit, along the nozzle axis 520. FIG. 5B illustrates velocity uneveness along the nozzle axis for natural gas operation with an air purge on the inner fuel circuit 530 and uneveness along the nozzle axis for natural gas operation without an air purge 540. These simulation results clearly demonstrate that the inner circuit air purge only alters the flow and mixing close to the nozzle injection location, but the that the unmixedness and velocity unevenness generally converge downstream in the mixing chamber. Analysis also reveals comparable axial velocity, fuel/air equivalence ratio and flow vector downstream from the nozzle injection. Thus, the re-designed dual fuel primary nozzle will not change its NG operability as compared with its original design. Experimental data has confirmed the computer simulation that NG operability has not been changed by the dual fuel nozzle redesign.

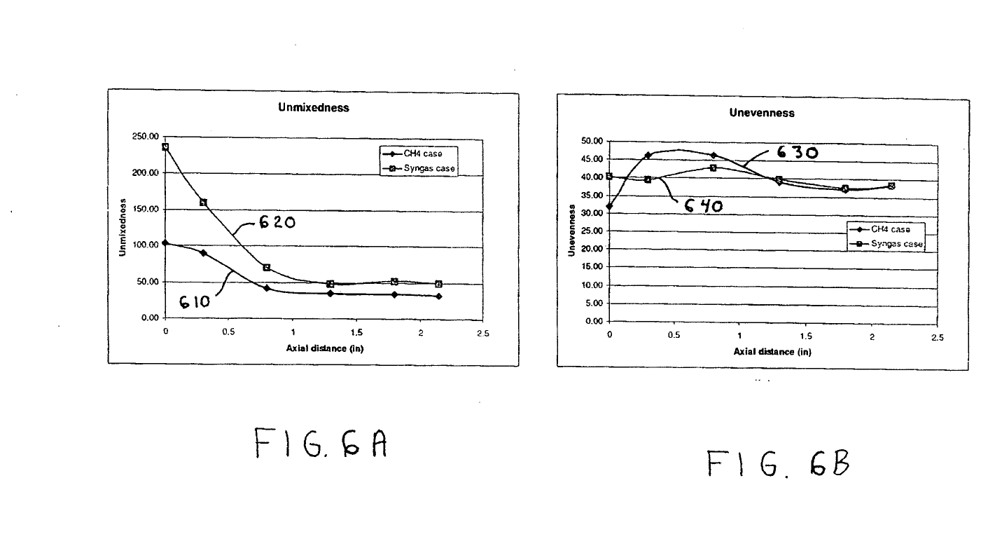

With syngas operation, the high volumetric syngas flow rate as compared with NG will inevitably alter the original flow and mixing patterns. Again CFD has been used as a tool to optimize the dual fuel primary nozzle design to achieve a minimum impact to the overall performances. A combination of the design parameters, including the fuel pressure ratio, fuel hole size, injector's swirl angle, injector's radial angle, and injector's location, has been utilized for design optimization. FIG. 6A and FIG. 6B illustrate a comparison for an embodiment of the dual fuel primary nozzle of fuel/air unmixedness and velocity uneveness in the mixing chamber between natural gas operation and syngas operation. FIG. 6A illustrates cross-section-averaged fuel/air unmixedness along the nozzle axis for natural gas operation 610 and cross-section-averaged fuel/air unmixedness along the nozzle axis for syngas operation 620. FIG. 6B illustrates velocity uneveness along the nozzle axis 630 for natural gas operation and velocity uneveness along the nozzle axis 640 for syngas gas operation. Analysis also reveals it is possible to limit differences between axial velocity, fuel/air equivalence ratio and flow vector to the first half of the downstream mixing chamber. These simulation results clearly demonstrate that by proper parametric combination selection, unmixedness and velocity unevenness values generally converge downstream in the mixing chamber for both natural gas and syngas operation. Thus, the dual fuel primary nozzle will not differ in operability for syngas as compared to operability with natural gas in its original design.

The present invention expands the fuel flexibility of the DLN-1 combustor gas fuels with a wide Wobbe number range, such as from natural gas to syngas (blended fuel). CFD has been used to optimize the fuel hole size, injection angles, and hole location to keep the overall combustor performances high. There is no change needed for the whole combustor except the primary nozzle. An inner fuel circuit is added to each primary nozzle to expand the fuel volumetric flow range. The nozzle has been tested for both natural gas and blended syngas. The test results demonstrate that the new nozzle performs as well as the single fuel nozzle for both natural gas and blended syngas.

While various embodiments are described herein, it will be appreciated from the specification that various combinations of elements, variations or improvements therein may he made, and are within the scope of the invention.

1. A dual fuel primary nozzle for a combustor of a gas turbine operating with a secondary nozzle and a plurality of the primary nozzles organized concentrically around the secondary nozzle wherein a gas fuel including one of a first gas fuel and a second gas fuel, a compressed air from the gas turbine compressor, and a purge air are supplied to the duel fuel primary nozzle, the dual fuel primary nozzle comprising:
a mixing chamber;
a swirler;
an outer fuel circuit in fluid communication with the mixing chamber and adapted for delivering one of a first gas fuel and a second gas fuel to mix with the swirled air in the swirler; and
an inner fuel circuit in fluid communication with the mixing chamber and adapted for delivering one of a purge air if the outer fuel circuit delivers a first gas fuel and for delivering a second gas fuel if the outer fuel circuit delivers the second gas fuel.

2. The dual fuel primary nozzle according to claim 1, wherein the first gas fuel comprises a Wobbe Index value disparate from a Wobbe Index value for the second gas fuel.

3. The dual fuel primary nozzle according to claim 2, wherein the first gas fuel comprises a natural gas and the second gas fuel comprises a syngas.

4. The dual fuel primary nozzle according to claim 3, wherein when the nozzle is operated on natural gas, the natural gas is supplied to the outer fuel circuit and purge air is supplied to the inner fuel circuit.

5. The dual fuel primary nozzle according to claim 1, wherein when nozzle is operated with the syngas, the syngas is supplied only to the outer fuel circuit until a fuel pressure ratio for the outer fuel circuit reaches a predetermined limit and after the fuel pressure ratio for the outer fuel circuit reaches the predetermined limit, then syngas is further supplied by the inner fuel circuit while maintaining the fuel pressure ratio at least one of at and below the predetermined limit for the outer fuel circuit and the inner fuel circuit.

6. The dual fuel primary nozzle according to claim 5, the predetermined limit for the fuel pressure ration comprising: about 1.4.

7. The dual fuel primary nozzle according to claim 1, wherein the inner fuel circuit is operable in a durable diffusion combustion mode on all gaseous fuels.

8. The dual fuel primary nozzle according to claim 1, wherein diluents may be injected into the mixing chamber through one of the inner fuel circuit and the outer fuel circuit.

9. The dual fuel primary nozzle according to claim 1, wherein one of the inner fuel circuit and the outer fuel circuit may be purged with one of air and a diluent.

10. The dual fuel primary nozzle according to claim 1, wherein the inner fuel circuit and the outer fuel circuit comprise co-firing two different types of gaseous fuel with separate fuel controls.

11. The duel fuel primary nozzle according to claim 1, further comprising:
a main body;
a center chamber in the main body, adapted for channelling the inner fuel circuit, including means of fluid communication with the mixing chamber;
an outer chamber in the main body, adapted for channelling the outer fuel circuit, including means of fluid communication with the mixing chamber; and
the swirler on the main body, including a plurality of swirler vanes, adapted to swirl a cross-flow of compressed air from an external volume of the nozzle to mix with one of the first gas fuel and the second gas fuel injected from the outer fuel circuit.

12. The dual fuel primary nozzle according to claim 11, wherein flow patterns and mixing patterns of the fuel-gas mixture for operation with natural gas in the outer fuel circuit and purge air in the inner fuel circuit for the dual fuel primary nozzle approximately converge in the mixing chamber with flow patterns and mixing patterns of the fuel-gas mixture for operation with a conventional DLN1 primary nozzle with natural gas only operation.

13. The dual fuel primary nozzle according to claim 11, wherein flow patterns and mixing patterns of the fuel-gas mixture for operation with syngas in the dual fuel primary nozzle approximately converge in the mixing chamber with flow patterns and mixing patterns of the fuel-gas mixture for operation of the dual fuel primary nozzle with natural gas operation.

14. The dual fuel primary nozzle according to claim 11, the means for fluid communication from the center chamber to the mixing chamber comprising:
a forward section of the center chamber extending into the mixing chamber, the forward section including a plurality of injection orifices between the forward section and the mixing chamber.

15. The dual fuel primary nozzle according to claim 14, the plurality of injection orifices comprising:
a central orifice on a central axis of the primary nozzle; and
a plurality of peripheral orifices organized about the central orifice.

16. The dual fuel primary nozzle according to claim 15, the peripheral orifices further comprising:
a predetermined orifice diameter;
a predetermined injection angle; and
predetermined locations on the forward end of the center chamber.

17. The dual fuel primary nozzle according to claim 11, the means of fluid communication for the outer chamber with the mixing chamber comprising:
a plurality of injection holes through a forward wall of the outer chamber, the injection holes being organized symmetrical to a central axis of the main body; and
a path between the plurality of swirl vanes of the swirler opening into the mixing chamber.

18. The dual fuel primary nozzle according to claim 17, the injection holes further comprising:
a predetermined orifice diameter;
a predetermined injection angle; and
predetermined locations on the forward wall of the outer chamber.

19. The dual fuel primary nozzle according to claim 17, the outer chamber further comprising:
a primary chamber;
a secondary chamber including the injection holes of the outer chamber;
a wall separating the primary and secondary chamber; and
a plurality of pre-orifices through the wall separating the primary and secondary chamber, wherein a size and a number of the plurality of pre-orifices are coordinated with a size and number of the plurality of injection holes of the outer chamber to substantially minimize, in the mixing chamber, fuel/air equivalence ratio fluctuations associated with combustion dynamics.

20. A method for fabricating a dual fuel primary nozzle for a combustor of a DLN1 gas turbine operating with a secondary nozzle positioned on a center axis of the combustor with a plurality of the primary nozzles organized concentrically around the secondary nozzle wherein a first gas fuel, a second gas fuel, a compressed air from the gas turbine compressor, and a purge air are supplied to the dual fuel primary nozzle, the method comprising:
fabricating a main body; a mixing chamber downstream from the main body; and a swirler positioned at a forward end of the main body and upstream from the mixing chamber, the swirler including a plurality of swirl vanes extending radially from the main body, and the swirler including means for fluid communication with an outer chamber of the main body and the mixing chamber for discharging a swirled mixture of compressed air and one of the first gas fuel and the second gas fuel into the mixing chamber;
forming a center chamber in the main body, the center chamber adapted to receiving one of a first gas fuel and a purge air from an inner fuel circuit and including means of fluid communication for discharging to the mixing chamber;
forming an outer chamber in the main body, the outer chamber adapted to receiving from an outer fuel circuit one of the first gas fuel and the second gas fuel and including means of fluid communication for discharging one of the first gas fuel and the second gas fuel into the plurality of swirl vanes of the swirler; and
receiving compressed air from an external volume bounded inward radially by an outer wall of the outer chamber of the main body and bounded on a downstream side by the swirl vanes of the swirler, the external volume being adapted to receiving compressed air from the gas turbine compressor for mixing by the swirl vanes with the one of the first gas fuel and the second gas fuel from the outer chamber;
receiving one of a first gas fuel and a second gas fuel in the outer chamber from the outer fuel circuit;
receiving an air purge from the inner fuel circuit to the center chamber when the first gas fuel is supplied to the outer chamber;
receiving the second gas fuel from the inner fuel circuit to the center chamber when second gas fuel is supplied to the outer chamber and once a fuel pressure ratio for the outer fuel circuit reaches a predetermined value; and
maintaining the fuel pressure ratio for the inner fuel circuit and the outer fuel circuit below the predetermined value when operating with the second gas fuel in both the inner fuel circuit and the outer fuel circuit.

21. A method for operation with a dual fuel primary nozzle for a combustor of a DLN1 gas turbine operating with a secondary nozzle positioned on a center axis of the combustor with a plurality of the primary nozzles organized concentrically around the center nozzle wherein a first gas fuel, a second gas fuel, a compressed air from the gas turbine compressor, and a purge air are supplied to the dual fuel primary nozzle, the method comprising:
forming an outer fuel circuit;
forming an inner fuel circuit; and
receiving compressed air from an external volume hounded inward radially by an outer wall of the outer chamber of the main body and bounded on a downstream side by the swirl vanes of the swirler, the external volume being adapted to receiving compressed air from the gas turbine compressor for mixing by the swirl vanes with the one of the first gas fuel and the second gas fuel from the outer chamber.

22. The method for operating a dual fuel primary nozzle according to claim 21, further comprising:
discharging a flow from the center chamber into the mixing chamber;
discharging a flow from the outer chamber into the swirler;
swirling the flow discharged from the outer chamber with the compressed air in the swirler;
discharging the gas fuel-air mixture from the swirler into the mixing chamber; and
mixing the flow from the first fuel circuit and the second fuel circuit with the compressed air in the mixing chamber.

23. The method for operating a dual fuel primary nozzle according to claim 22, the step of discharging a flow from the center chamber comprising:
discharging the flow through a plurality of injection orifices between the forward section of the center chamber and the mixing chamber including a center orifice on the central axis of the dual fuel primary nozzle and a plurality of peripheral orifices radially and circumferentially symmetric about the central orifice, wherein the plurality of injection orifices include a predetermined orifice diameter; a predetermined injection angle; and predetermined locations on the forward end of the center chamber.

24. The method for operating a dual fuel primary nozzle according to claim 23, the step of discharging a flow from the outer chamber into the swirler comprising:
discharging the flow through a plurality of injection orifices between the forward wall of the outer chamber and the swirler, the plurality of injection orifices positioned radially and circumferentially symmetric about the central axis of the primary nozzle, wherein the plurality of injection orifices include a predetermined orifice diameter; a predetermined injection angle; and predetermined locations on the forward end of the wall chamber.

25. The method for operating a dual fuel primary nozzle according to claim 22, further comprising:
mixing the gas from the center chamber with the gas fuel-air mixture from the swirler in the mixing chamber.

26. The method for operating a dual fuel primary nozzle according to claim 25, the step of mixing the gas from the center chamber with the gas fuel-air mixture from the swirler in the mixing chamber, wherein the first gas fuel comprises natural gas and the second gas fuel comprises syngas.

27. The method for operating a dual fuel primary nozzle according to claim 22, the step of mixing comprising:
forming a fuel-air mixture within the mixing chamber, wherein flow patterns and mixing patterns of the fuel-gas mixture for operation with natural gas as the first gas fuel in the outer fuel circuit and purge air in the inner fuel circuit approximately converge in the mixing chamber with flow patterns and mixing patterns of the fuel-gas mixture for operation with a conventional DLN1 primary nozzle with natural gas only operation.

28. The method for operating a dual fuel primary nozzle according to claim 22, the step of mixing comprising:
forming a fuel-air mixture within the mixing chamber wherein flow patterns and mixing patterns of the fuel-gas mixture for operation with syngas as the second gas fuel approximately converge in the mixing chamber with flow patterns and mixing patterns of the fuel-gas mixture for operation of the dual fuel primary nozzle with natural gas operation.
